(19) United States
(12) Patent Application Publication
(10) Pub. No.: US 2006/0201369 A1
(43) Pub. Date: Sep. 14, 2006

(54) Igniter assembly

(75) Inventors: Takao Kuroda, Ibo-gun (JP); Shingo Oda, Ibo-gun (JP); Shigeaki Yano, Ibo-gun (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/361,996

(22) Filed: Feb. 27, 2006

Related U.S. Application Data
(60) Provisional application No. 60/658,592, filed on Mar. 7, 2005.

(30) Foreign Application Priority Data
Feb. 28, 2005 (JP) 2005-53862

(51) Int. Cl. C06B 45/00; B60R 21/26

(52) U.S. Cl. 102/289; 280/741

(57) ABSTRACT

The present invention relates to an igniter assembly including an igniter main body accommodated in an igniter collar, the igniter main body fixed within the igniter collar by a resin, the igniter collar having at least a cylindrical wall and an annular protruding portion protruding inward from a part of the cylindrical wall, the resin charged so as to extend from a position sandwiching the annular protruding portion from the upper and lower directions up to the same height as an upper end of the cylindrical wall, but not to cover an outer peripheral wall of the cylindrical wall.

This nonprovisional application claims priority under 35 U.S.C. §119(a) on Patent Application No.2005-53862 filed in Japan on Feb. 28, 2005 and 35 U.S.C. §119(e) on U.S. Provisional Application No. 60/658592 filed on Mar. 7, 2005, which are incorporated by reference.

### BACKGROUND OF THE INVENTION

1. Field of the Invention

The present invention relates to an igniter assembly which can be used in a gas generator for an air bag.

2. Description of the Related Art

An igniter assembly having a structure in which an igniter main body and a collar for supporting the igniter main body are integrated using resin is advantageous in that the manufacturing process thereof can be simplified. However, the molten resin may shrink upon hardening, creating gaps between the resin and the igniter main body or collar. This shrinkage can be suppressed by selecting an appropriate resin, but cannot be prevented completely.

An igniter assembly is applied to a passenger restraining device such as a gas generator for an air bag, and in order to prevent moisture infiltration, the gas generator should be sealed completely the interior thereof from the exterior. However, when gaps such as those described above occur between the igniter main body and the resin, or between the collar and the resin, moisture may infiltrate from the outside.

U.S. Pat. No. 5,533,754, U.S. Pat. No. 5,584,505, and JP-A No. 2003-161599 disclose igniter assemblies having a structure in which an igniter main body is integrated with the inner and outer walls on the upper portion of the collar using resin.

### SUMMARY OF THE INVENTION

An aspect of the present invention relates to an igniter assembly including an igniter collar having at least a cylindrical wall and an annular protruding portion protruding inward from a part of the cylindrical wall and an igniter main body, the igniter main body being accommodated in the igniter collar and fixed within the igniter collar with a resin, the resin being charged so as to extend from a position sandwiching the annular protruding portion from the upper and lower directions up to the same height as the upper end of the cylindrical wall, but not to cover an outer peripheral wall of the cylindrical wall.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a longitudinal sectional view of an igniter assembly;

FIG. 2 shows a longitudinal sectional view of an igniter assembly according to another embodiment;

FIG. 3 shows a longitudinal sectional view of an igniter assembly according to another embodiment; and

FIG. 4. shows a longitudinal sectional view of an igniter assembly according to another embodiment.

### DETAILED DESCRIPTION OF THE INVENTION

Upon hardening, the molten resin shrinks toward the inside, but when the inner and outer walls on the upper portion of the collar are both covered with the resin, as described in U.S. Pat. No. 5,533,75, U.S. Pat. No. 5,584,505, and JP-A No. 2003-161599, the resin covering the outer wall acts to obstruct shrinkage of the resin toward the inside of the collar, and as a result, gaps become more likely to occur between the igniter main body and the resin.

The present invention further relates to an igniter assembly which is suitable for use in a gas generator for an air bag, and which has a structure that prevents gaps from occurring between a collar and a resin, and between an igniter main body and the resin, even when the molten resin hardens during assembly.

When the molten resin charged into the igniter collar hardens, shrinkage occurs in a central direction. At this time, the igniter collar is positioned further outward than the igniter main body, and hence, if no restrictions are provided, the resin shrinks so as to separate from the igniter collar, enabling gaps to form between the igniter collar and the hardened resin.

However, when the resin is charged so as to extend from a position sandwiching the annular protruding portion from the upper and lower directions up to the same height as the upper end of the cylindrical wall, as in the present invention, the cylindrical wall does not affect the resin shrinking in the central direction, and hence the formation of gaps between the igniter collar and the hardened resin is suppressed. Moreover, the annular protruding portion can be sandwiched tightly by the resin from the upper and lower directions thereof, using the shrinkage force of the resin, and hence even if gaps are formed between the cylindrical wall and the resin, sealing is exhibited at the annular protruding portion, preventing the infiltration of moisture and so on.

Furthermore, the outer peripheral wall of the igniter collar is not covered by the resin. When the resin covers the outside of the igniter collar, as in U.S. Pat. No. 5,533,754, U.S. Pat. No. 5,584,505, and JP-A No. 2003-161599, the central direction-shrinkage force of the resin, generated during hardening and shrinkage, acts on the outer peripheral wall, causing the resin covering the-igniter main body to shrink in the opposite direction, i.e. outward. As a result, gaps become more likely to form between the igniter main body and resin.

Note that even when a gap occurs between the igniter collar and resin, the annular protruding portion is attached tightly to the resin, and hence penetrating gaps which impair the moisture resistance of the igniter assembly do not occur.

The present invention further relates to the igniter assembly, wherein the resin is charged so as to extend from the position sandwiching the annular protruding portion from the upper and lower directions up to a height covering an upper end edge of the cylindrical wall, but does not cover the outer peripheral wall of the cylindrical wall.

By charging the resin up to a height covering the upper end edge of the cylindrical wall, the contact surface area between the igniter main body and the resin is increased, and hence the binding strength of the igniter main body and resin is increased.

The present invention further relates to the igniter assembly, wherein the resin is charged so as to extend from the position sandwiching the annular protruding portion from the upper and lower directions up to a height covering an upper end edge of the cylindrical wall, and also so as to protrude outward, but does not cover the outer peripheral surface of the cylindrical wall.

By charging the resin up to a height covering the upper end edge of the cylindrical wall, the contact surface area between the igniter main body and the resin is increased, and hence the binding strength of the igniter main body and resin is increased. Moreover, by charging the resin to protrude outward, when the igniter assembly is disposed in an igniter accommodation space of a gas generator, the igniter accommodation space contacts the protruding portion of the resin, thereby generating friction which prevents the igniter assembly from rotating.

The present invention further relates to the igniter assembly, wherein the igniter main body includes a header portion, a conductive pin extending from the header portion, and a cup portion covering the header portion and filled with an ignition charge therein, and at least half the entire height of the cup portion of the igniter main body is enveloped by the cylindrical wall of the igniter collar.

When the igniter assembly is activated, the ignition charge burns, causing the cup portion to expand outward. At this time, it is conceivable for the resin on the outside of the cup portion also to deform, but since the cylindrical wall of the igniter collar exists on the outer periphery of the resin, deformation of the resin is suppressed, and the formation of gaps between the igniter main body and resin is suppressed.

The present invention further relates to the igniter assembly, wherein an upper end opening portion peripheral edge of the cylindrical wall is formed so as to incline inward.

The present invention further relates to the igniter assembly, wherein a part of an inner peripheral surface of the cylindrical wall which contacts the resin has irregularities such as unevenness or a projection(s).

By providing such irregularities, the irregular portions engage with the resin, and hence the hardened resin can be prevented from rotating inside the igniter collar.

In the igniter assembly of the present invention, axially penetrating gaps do not occur between the igniter collar and resin, and between the igniter main body and resin, even when the resin shrinks during the hardening process. Hence, when the igniter assembly is incorporated into a gas generator, external moisture does not pass through the igniter assembly to infiltrate the interior of the gas generator.

### EMBODIMENTS OF THE INVENTION

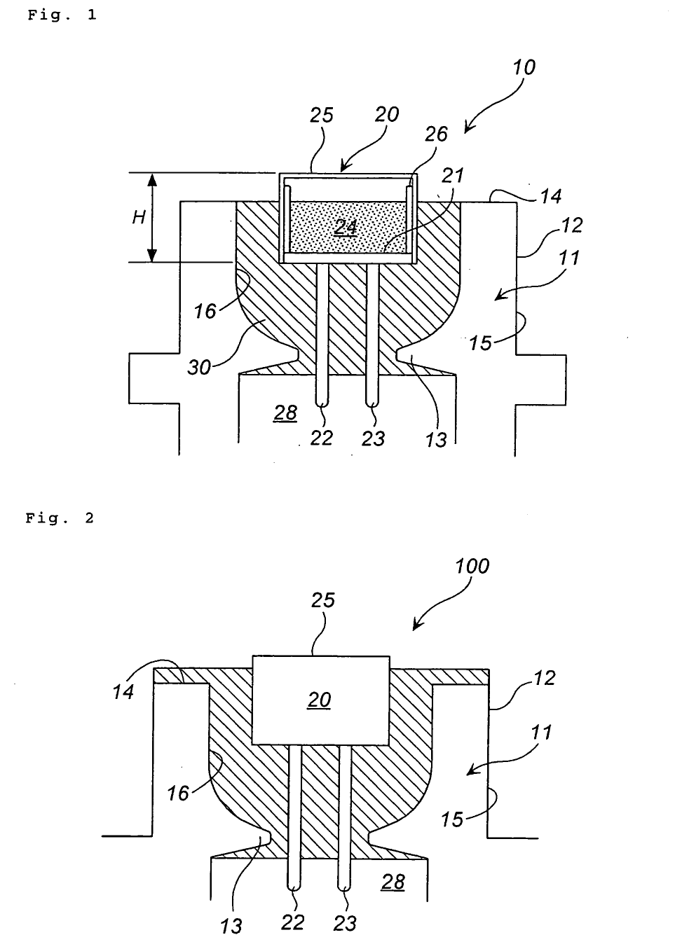

(1) Igniter Assembly of FIG. 1

The igniter assembly shown in FIG. 1 is a longitudinal sectional view of an igniter assembly.

An igniter collar 11 is a metallic, substantially cylindrical component including a cylindrical wall 12, and an annular protruding portion 13 protruding inward from a part of the cylindrical wall 12. An inner peripheral surface 16 extending from an upper end edge 14 of the cylindrical wall 12 to the annular protruding portion 13 is curved.

If necessary, a plurality of uneven surfaces or projections may be provided on the inner peripheral surface 16 to prevent a resin 30 from rotating within the igniter collar 11. The irregularities may be provided over the entire inner peripheral surface 16, or at equal intervals. The irregularities may be provided continuously or non-continuously in either the axial direction or the circumferential direction on the inner peripheral surface from the upper end edge 14 to the annular protruding portion 13.

An igniter main body 20 includes a header portion 21, two conductive pins 22, 23 extending from the header portion 21, and a cup portion 25 covering the header portion 21, the interior of which is charged with an ignition charge 24. A cylindrical sleeve 26 is disposed in the cup portion 25. A heat generating body, not shown in the drawing, is disposed in the header portion 21.

The igniter main body 20 is fixed inside the igniter collar 11 by the resin 30. The resin 30 extends from a position sandwiching the annular protruding portion 13 from the upper and lower directions to the same height as (flush with) the upper end edge 14 of the cylindrical wall 12. However, the resin 30 does not cover an outer peripheral surface 15 of the cylindrical wall 12. As shown in the drawing, the conductive pins 22, 23 are covered with resin except for the tip end portions thereof, which are connected to a connector (i.e. fitted into a connector accommodating space 28).

At least half the entire height H of the cup portion 25 of the igniter main body 20 is enveloped by the resin 30, and the periphery of the resin 30 is enveloped by the cylindrical wall 12. If the cylindrical wall 12 is not provided, the resin 30 on the outside of the cup portion 25 deforms outwardly as the cup portion 25 expands outward upon combustion of the ignition charge 24 when the igniter assembly 10 is activated, but since the cylindrical wall 12 of the igniter collar 11 exists on the outer periphery of the resin 30, deformation of the resin 30 is suppressed, and hence gaps are unlikely to form between the igniter main body 20 and resin 30.

Note that although deformation of the resin 30 is suppressed in this manner, holes defined by the annular protruding portion 13 are set to be smaller than the diameter of the cup portion 25 of the igniter main body 20, and hence even in situations where the resin 30 deforms greatly upon activation of the igniter assembly 10, the igniter main body 20 does not fall downward from the igniter collar 11.

During assembly of the igniter assembly 10, molten resin is charged using an injection molding method or the like to obtain the state shown in the drawing, whereupon hardening of the resin progresses. During this hardening process, the resin 30 shrinks in a central direction. At this time, the annular protruding portion 13 is sandwiched by the resin 30 from the upper and lower directions in FIG. 1 (the thickness direction). Hence, the formation of gaps between the annular protruding portion 13 and the hardened resin 30 can be suppressed, and the shrinkage force of the resin 30 can be used to sandwich the annular protruding portion 13 tightly with the resin 30 from the upper and lower directions.

On the other hand, the cylindrical wall 12 exists on the outside of the resin 30, and hence gaps are likely to form between the inner peripheral surface 16 of the cylindrical wall 12 and the resin 30 during the hardening process. However, the annular protruding portion 13 and resin 30 are attached tightly to each other, and hence when the igniter assembly 10 is attached to a gas generator, gaps which penetrate the interior of the gas generator from the connector accommodation space 28 do not form.

Furthermore, the resin 30 does not cover the outer peripheral surface 15 of the cylindrical wall 12, and hence shrinkage of the resin 30 occurs toward the igniter main body 20 during the hardening process. As a result, gaps do not form between the igniter main body 20 and resin 30.

Resin having a mold shrinkage rate of not more than 1% is preferably employed as the resin of the present invention, and resin having a mold shrinkage rate between 0.1 and 0.8% is particularly preferable. When the mold shrinkage rate is not more than 1%, the hardened resin does not deform, warp or have any rough surface or asperities, and as a result, penetrating gaps can be prevented from forming between the igniter main body 20 and the resin 30, or between the igniter collar 11 and the resin 30. Further, when the mold shrinkage rate is not less than 0.1%, the annular protruding portion 13 can be sandwiched more securely as a result of the mold shrinkage in the resin, which is preferable.

It is known that a substance obtained by combining an inorganic filling material such as glass fiber or inorganic filler with resin has a different mold shrinkage rate in the flow direction of the injection-molded resin (MD) and a perpendicular direction thereto (TD) due to the orientation of the inorganic filling material. Hence, when this type of resin combined with an inorganic filling material is used, the employed resin preferably has a mold shrinkage rate (in the flow direction and perpendicular direction) that is at least sufficient to prevent undesirable gaps from forming between the igniter main body 20 and resin 30, between the igniter collar 11 and resin 30, and so on.

A thermosetting resin may be used as the resin, but in consideration of the injection molding process, it is preferable for such a resin to be thermoplastic, and even more preferable for the resin to be combined with glass fiber or another inorganic filling material.

The water absorption of the resin after submersion for 24 hours at 23° C. (likewise hereafter) is preferably between 0.005 and 0.5%, and more preferably between 0.005 and 0.3%. The tensile strength of the resin is preferably between 70 and 250 MPa, more preferably between 100 and 250 MPa, and even more preferably between 170 and 250 MPa. Further, the employed resin preferably has a linear expansion coefficient of not more than 8×10⁻⁵/° C., a tensile strength of not less than 100 MPa, and a dielectric breakdown voltage of not less than 10 MV/m.

Examples of such a resin include nylon 6-12, polyallylate, polybutylene terephthalate, polyphenylene sulphide, and liquid crystal polymer. These resins may be combined with an inorganic filling material such as glass fiber, glass filler, or a mineral. Polybutylene terephthalate containing 20 to 80% by mass of glass fiber, polyphenylene sulphide containing 20 to 80% by mass of glass fiber, and liquid crystal polymer containing 20 to 80% by mass of mineral are particularly preferable.

When a glass-reinforced resin containing glass fiber is used, the orientation of the glass fiber is preferably adjusted so as to be aligned with the extension direction of the conductive pins inserted into the resin. In so doing, the mold shrinkage rate increases in the thickness direction of the conductive pins 22, 23, and moisture permeation between the conductive pins 22, 23 and resin 30 can be prevented reliably. Further, the inorganic filling material content in each of the resin materials is preferably between 20 and 50% by mass.

In the present invention, nylon 6-12 containing 33% by mass of glass fiber (and having a mold shrinkage rate in the flow direction of 0.2%, a mold shrinkage rate in the perpendicular direction of 0.3%, and a linear expansion coefficient of 2.3×10⁻⁵/° C.) may be used. When this type of resin is used, a favorable mold shrinkage rate for sandwiching the annular protruding portion 13 from the upper and lower directions can be exhibited, and deformation, warping, and so on after molding can be suppressed.

(2) Igniter Assembly of FIG. 2

The igniter assembly shown in FIG. 2 is a longitudinal sectional view of an igniter assembly. An igniter assembly 100 shown in FIG. 2 is substantially identical in structure to the igniter assembly 10 of FIG. 1, and therefore only different portion will be described. Note that identical reference numerals to those of FIG. 1 denote identical components in FIG. 2.

The resin 30 extends from a position sandwiching the annular protruding portion 13 from the upper and lower directions to the portion above the upper end edge 14 of the cylindrical wall 12, but the outer peripheral surface 15 of the cylindrical wall 12 is not covered by the resin 30. At least half the entire height H of the cup portion 25 of the igniter main body 20 (the top of the upper end edge 14 is covered with the resin 30, and therefore the part of the cup portion 25 that is enveloped by the resin 30 increases proportionately in comparison with FIG. 1) is enveloped by the resin 30, while the periphery of the resin 30 is enveloped by the cylindrical wall 12.

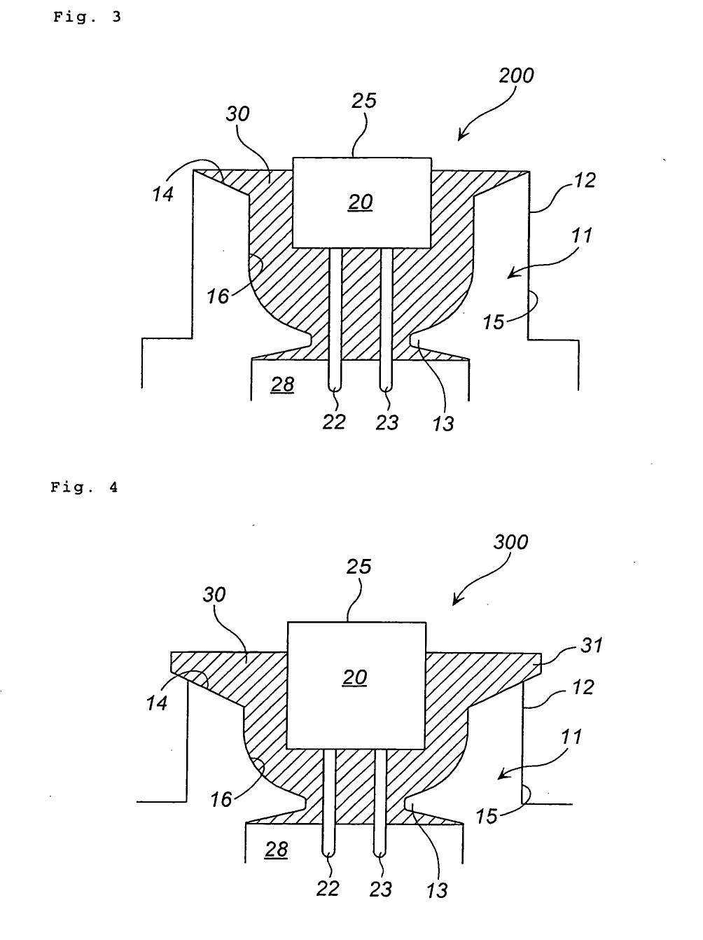

(3) Igniter Assembly of FIG. 3

The igniter assembly shown in FIG. 3 is a longitudinal sectional view of an igniter assembly. An igniter assembly 200 shown in FIG. 3 is substantially identical in structure to the igniter assembly 10 of FIG. 1, and therefore only different portion will be described. Note that identical reference numerals to those of FIG. 1 denote identical components in FIG. 3.

The cylindrical wall 12 of the igniter collar 11 is formed such that the upper end edge 14 is inwardly inclined. The resin 30 extends from a position sandwiching the annular protruding portion 13 from the upper and lower directions to the portion above the upper end edge 14 of the cylindrical wall 12, but the outer peripheral surface 15 of the cylindrical wall 12 is not covered by the resin 30.

At least half the entire height H of the cup portion 25 of the igniter main body 20 (the top of the upper end edge 14 is covered with the resin 30, and therefore the part of the cup portion 25 that is enveloped by the resin 30 increases proportionately in comparison with FIG. 1) is enveloped by the resin 30, while the periphery of the resin 30 is enveloped by the cylindrical wall 12.

(4) Igniter Assembly of FIG. 4

The igniter assembly shown in FIG. 4 is a longitudinal sectional view of an igniter assembly. An igniter assembly 300 shown in FIG. 4 is substantially identical in structure to the igniter assembly 10 of FIG. 1, and therefore only different portion will be described. Note that identical reference numerals to those of FIG. 1 denote identical components in FIG. 4.

The cylindrical wall 12 of the igniter collar 11 is formed such that the upper end edge 14 is inwardly inclined. The resin 30 extends from a position sandwiching the annular protruding portion 13 from the upper and lower directions to the portion above the upper end edge 14 of the cylindrical wall 12, and also protrudes outward to form an annular protruding portion 31. The outer peripheral surface 15 of the cylindrical wall 12 is not covered by the resin 30. The protruding portion 31 may be a plurality of independent protrusions rather than being annular.

By providing the annular protruding portion 31 in this manner, the annular protruding portion 31 contacts the inner surface of the igniter accommodation space when the igniter assembly 10 is mounted in the igniter accommodation space of a gas generator, thereby generating friction which prevents the igniter assembly 10 from rotating.

At least half the entire height H of the cup portion 25 of the igniter main body 20 (the top of the upper end edge 14 is covered with the resin 30, and therefore the part of the cup portion 25 that is enveloped by the resin 30 increases proportionately in comparison with FIG. 1) is enveloped by the resin 30, while the periphery of the resin 30 is enveloped by the cylindrical wall 12.

The invention thus described, it will be obvious that the same may be varied in many ways. Such variation s are not to be regarded as a departure from the spirit and scope of the invention, and all such modifications as would be obvious to one skilled in the art are intended to be included within the scope of the following claims.

1. An igniter assembly comprising an igniter collar having at least a cylindrical wall and an annular protruding portion protruding inward from a part of the cylindrical wall and an igniter main body, the igniter main body being accommodated in the igniter collar and fixed within the igniter collar with a resin, the resin being charged so as to extend from a position sandwiching the annular protruding portion from upper and lower directions up to the same height as an upper end of the cylindrical wall, but to cover no outer peripheral wall of the cylindrical wall.

2. The igniter assembly according to claim 1, wherein the resin is charged so as to extend from the position sandwiching the annular protruding portion from the upper and lower directions up to a height covering the upper end edge of the cylindrical wall, but does not cover the outer peripheral wall of the cylindrical wall.

3. The igniter assembly according to claim 1, wherein the resin is charged so as to extend from the position sandwiching the annular protruding portion from the upper and lower directions up to a height covering an upper end edge of the cylindrical wall, and also so as to protrude outward, but does not cover the outer peripheral surface of the cylindrical wall.

4. The igniter assembly according to claim 1, wherein the igniter main body comprises a header portion, a conductive pin extending from the header portion, and a cup portion covering the header portion and filled with an ignition charge, and at least half an entire height of the cup portion of the igniter main body is enveloped by the cylindrical wall of the igniter collar.

5. The igniter assembly according to claim 1, wherein an upper end opening portion peripheral edge of the cylindrical wall is formed so as to incline inward.

6. The igniter assembly according to claim 1, wherein a part of an inner peripheral surface of the cylindrical wall which contacts the resin has irregularities or is uneven.

7. The igniter assembly according to claim 2, wherein the igniter main body includes a header portion, a conductive pin extending from the header portion, and a cup portion covering the header portion and filled with an ignition charge, and at least half of an entire height of the cup portion is enveloped by the cylindrical wall of the igniter collar.

8. The igniter assembly according to claim 2, wherein a peripheral edge of an upper end opening portion provided in the cylindrical wall is formed with a surface that is inclined inwardly.

9. The igniter assembly according to claim 2, wherein at least a part of an inner peripheral surface of the cylindrical wall which contacts the resin has irregularities or is uneven.

10. An igniter assembly, comprising:
an igniter collar provided with a cylindrical wall extending in an axial direction thereof and an annular protruding portion protruding inward from a portion of the cylindrical wall;
an igniter main body accommodated and fixed within the igniter collar such that the cylindrical wall is provided outside the igniter main body; and
a resin provided within the igniter collar and fixing the igniter main body within the igniter collar such that the annular protruding portion is sandwiched by the resin and the resin covers other than an outer periphery of the cylindrical wall.

11. The igniter assembly according to claim 10, wherein the resin is provided such that an upper end of the cylindrical wall is covered with resin.

12. The igniter assembly according to claim 10, wherein the resin is provided such that the upper end of the cylindrical wall is covered with resin and the resin extends outward from the outer periphery of the cylindrical wall.

13. The igniter assembly according to claim 10, wherein the igniter main body includes a header portion, a conductive pin extending from the header portion, and a cup portion covering the header portion and filled with an ignition charge, and at least half an entire height of the cup portion is enveloped by the cylindrical wall.

14. The igniter assembly according to claim 10, wherein an upper end of the cylindrical wall is provided with an inclined surface inclined inwardly.

15. The igniter assembly according to claim 1, wherein a part of an inner peripheral surface of the cylindrical wall which contacts the resin has irregularities or is uneven.
